(19) United States
(12) Patent Application Publication
(10) Pub. No.: US 2002/0062885 A1
(43) Pub. Date: May 30, 2002

(54) Co-Mn-Fe soft magnetic alloys

(76) Inventor: Lin Li, Reading, PA (US)

Correspondence Address: DANN DORFMAN HERRELL & SKILLMAN, SUITE 720, 1601 MARKET STREET, PHILADELPHIA, PA, 19103-2307, US

(21) Appl. No.: 09/970,557

(22) Filed: Oct. 4, 2001

Related U.S. Application Data
(60) Provisional application No. 60/238,982, filed on Oct. 10, 2000.

(51) Int. Cl. H01F 1/147

(52) U.S. Cl. 148/311

(57) ABSTRACT

A soft magnetic steel alloy contains in weight percent, about 1.0-5.0% manganese, about 7-17% cobalt, and the balance is essentially iron. The disclosed alloy provides a highly acceptable level of magnetic saturation induction combined with good electrical resistivity with a substantially reduced amount cobalt relative to the known Co—Fe soft magnetic steel alloys.

This application claims the benefit of priority from copending U.S. Provisional Application No. 60/238,982, filed Oct. 10, 2000.

### FIELD OF THE INVENTION

This invention relates to soft magnetic steel alloys that contain cobalt, and in particular, to a soft magnetic steel alloy containing manganese and less than 20% by weight of cobalt.

### BACKGROUND OF THE INVENTION

49Co-49Fe-2V (HIPERCO® Alloy 50) and 27Co—Fe (HIPERCO Alloy 27) are known alloys that provide very high magnetic saturation induction as demonstrated by a saturation induction, B_{s,} of about 23-24 kG. Those alloys have been used in motor and transformer applications for the aerospace industry. They are relatively expensive alloys because they contain substantial amounts of cobalt.

In land-based applications, such as automobiles and trucks, there has developed a need for a soft magnetic material with very high magnetic saturation induction. Examples of articles where such alloys would be desirable include solenoids, fuel injectors, switched reluctance motors, magnetic bearings, fly wheels, and sensors. However, cobalt-containing alloys such as HIPERCO Alloy 50 and HIPERCO Alloy 27 have not been considered for automotive applications because of they are substantially more expensive than the known soft magnetic alloys that do not contain a deliberate addition of cobalt. One way to improve the utility of cobalt-containing soft magnetic alloys for automotive use is to reduce the amount of cobalt used in such alloys, thereby lowering the cost of producing such alloys. However, the saturation induction must be kept reasonably high (i.e., at least about 21 kG).

The resistivity (ρ) of an Fe—Co alloy containing less than about 20% cobalt is only about 20 μΩ·cm. That is substantially lower than the resistivity provided by the HIPERCO 50 Alloy which is typically about 40 μΩ·cm, for example. The lower resistivity of the lower cobalt alloy results in higher core loss which is not acceptable for many applications.

The prior art has sought to overcome the problem of low resistivity in Co—Fe alloys containing 20% or less cobalt by adding elements such as chromium, molybdenum, vanadium, and tungsten, or silicon and aluminum, to the basic alloy. However, such element additions increase the raw material cost of making the alloys. Also, the scrap metal from making such alloys is less useful as a general recycling material for other grades of steel because it so highly alloyed.

The elements chromium, molybdenum, vanadium, and tungsten are carbide-formers. When carbon is used as a deoxidizer in making soft magnetic alloys, the presence of a significant amount of one or more of those elements is likely to result in degraded magnetic properties from the precipitation of carbides. This is a real concern for Ni—Fe soft magnetic alloys because they are often melted in the same VIM furnace as the Co—Fe grades. Such carbide-forming elements are usually restricted to as low as possible in Ni—Fe alloys because of their known adverse effects on the magnetic properties.

There are also problems associated with the use of silicon and aluminum to increase electrical resistivity. Those elements are highly reactive and can cause difficulties in melting. Significant additions of silicon and aluminum are also likely to cause brittleness in the steel. Moreover, aluminum is detrimental to the properties of Ni—Fe soft magnetic steels and, again, there is a substantial risk of contamination if the Ni—Fe grades are melted in the same VIM furnace as the Co—Fe grades.

### SUMMARY OF THE INVENTION

The problems associated in providing a reduced-cobalt soft magnetic steel alloy are resolved to a large degree by a soft magnetic steel alloy in accordance with the present invention. The alloy of this invention has the following Broad and Preferred weight percent compositions.

| | Broad | Preferred A | Preferred B |
|---|---|---|---|
| Manganese | 1.0-5.0 | 2.2-3.2 | 1.8-2.4 |
| Cobalt | 7-17 | 14-16 | 7-9 |
| Iron | Balance | Balance | Balance |

The balance in each case is essentially iron and includes the usual impurities found in commercial grades of soft magnetic steel alloys intended for the same or similar use or service. Minor amounts of the elements carbon, silicon, chromium, and nickel may be present in this alloy if desired.

The foregoing tabulation is provided as a convenient summary and is not intended thereby to restrict the lower and upper values of the ranges of the individual elements of the alloy of this invention for use in combination with each other, or to restrict the ranges of the elements for use solely in combination with each other. Thus, one or more of the element ranges of the broad composition can be used with one or more of the other ranges for the remaining elements in a preferred composition. In addition, a minimum or maximum for an element of one preferred embodiment can be used with the maximum or minimum for that element from another preferred embodiment. Throughout this application, the term “percent” or the symbol “%” means percent by weight, unless otherwise indicated.

### DETAILED DESCRIPTION

The alloy according to the present invention contains at least about 7% cobalt to benefit the magnetic induction provided by the alloy. In a first preferred composition, the alloy contains at least about 14% cobalt. In a second preferred composition, the alloy contains at least about 7% cobalt. Not more than about 17% cobalt is present in this alloy to keep the raw material cost at a low level relative to the known grades of Co—Fe soft magnetic alloys. In the first preferred composition, the alloy contains not more than about 16% cobalt and in the second preferred composition the alloy contains not more than about 9% cobalt.

The alloy according to this invention also contains at least about 1.0% manganese to benefit the resistivity provided by this alloy. At the higher levels of cobalt present in the first preferred composition, at least about 2.2% manganese is present. At the lower levels of cobalt present in the second preferred composition, the alloy contains at least about 1.8% manganese.

Too much manganese adversely affects the saturation magnetic induction provided by this alloy. Excessive manganese can also result in the precipitation of an additional phase that adversely affects the coercive force provided by this alloy. Therefore, the alloy is restricted to not more than about 5.0% manganese. The first preferred composition of this alloy contains not more than about 3.2% manganese and the second preferred composition manganese contains not more than about 2.4% manganese.

The balance of the alloy is essentially iron and the usual impurities found in commercial grades of soft magnetic alloys intended for the same or similar use or service. A small amount of carbon may be present from deoxidizing additions when the alloy is melted. However, the amount of carbon is controlled so that the amount retained in the solidified ingot is as low as practically possible, preferably not more than about 0.02%, better yet, not more than about 0.01%, in order to avoid the formation of carbides in the alloy. A small amount of silicon, up to about 0.3%, may also be present in the alloy either as a result of a deoxidizing addition to the melt or as a positive addition to stabilize the ferritic structure of the alloy. Silicon also increases the useable tempering temperature for the two-step heat treatment that can be used to process this alloy. A small amount of chromium up to about 0.8%, preferably not more than about 0.5%, may also be present in this alloy to stabilize the ferritic structure and to permit a higher tempering temperature to be used in the two-step heat treatment mentioned above. The amounts of silicon and chromium that may be present in this alloy are not expected to have a significant effect on the resistivity of the alloy, compared to the effect on that property from the presence of the relatively higher amounts of manganese. Up to about 0.8% nickel may be present in this alloy to benefit the resistivity of the alloy.

No special techniques are needed to make the alloy according to this invention. The alloy is preferably melted by vacuum induction melting (VIM). When desired, higher purity or better grain structure can be obtained by refining the alloy, such as by electroslag remelting (ESR) or vacuum arc remelting (VAR). The alloy is cast into ingot form which is then hot worked into billet, bar, or slab from a preheat temperature of about 2200° F. The alloy is then hot rolled to wire, rod, or strip of intermediate thickness. The wire, rod, or strip may then be cold worked to smaller cross-sectional dimension from which it can be machined into finished parts. This alloy may also be made using powder metallurgy techniques to make net-shaped and near net-shaped articles.

To develop the desired magnetic properties, parts made from this alloy are annealed after cold working and after being machined into the desired shape. It has been found that in order to develop the best magnetic properties, the annealing heat treatment is selected with reference to the composition of the alloy. Thus, when the alloy contains about 7-9% cobalt and less than about 3% manganese, the alloy is preferably annealed at about 1400-1500° F. for about 2-4 hours followed by cooling at about 150° F. per hour. When the alloy contains about 14-16% cobalt and about 2.5-3.7% manganese, the alloy is preferably annealed using a two-step annealing process in which the alloy is heated at about 2100-2200° F. for a time long enough to substantially eliminate dislocations and to maximize grain size. This will typically be about 4-6 hours at temperature. The alloy is then furnace cooled at about 200° F./hour to about 1200-1300° F. and then held at that temperature for about 24 hours to substantially eliminate any γ-phase.

The alloy according to this invention is capable of providing a magnetic induction, B, at 200 Oe of about 21.4 kG and a resistivity, ρ, of about 42.4 μΩ·cm. In comparison, of the known alloys containing substantially more cobalt, HIPERCO Alloy 50 provides a D.C. magnetic induction of about 24 kG at 200 Oe and an electrical resistivity of about 40 μΩ·cm, whereas HIPERCO Alloy 27 provides a D.C. magnetic induction of about 23 kG at 200 Oe and an electrical resistivity of about 19 μΩ·cm. It is expected that the alloy according to this invention can be processed into bar, plate, wire, and strip forms, as desired. The alloy is especially suitable for use in magnetic devices such as, solenoids, fuel injectors, switched reluctance motors, magnetic bearings, flywheels, and magnetic sensors. The alloy is also expected to be used in such devices as brushless alternators, compressor motors, magnetic suspension systems, and pole pieces for linear motors.

### WORKING EXAMPLES

Examples of the alloy according to this invention were prepared by vacuum induction melting and split-cast as small (8 lb) ingots. The chemical analyses of the ingots are listed in Table I in weight percent.

TABLE I
Chemical analysis of Co—Mn—Fe alloys

| Heat ID | C | Mn | Si | P | S | Cr | Ni | Mo | Co |
|---|---|---|---|---|---|---|---|---|---|
| 8Co2Mn | 0.002 | 2.08 | 0.23 | <0.005 | 0.001 | <0.01 | 0.42 | <0.01 | 8.00 |
| 8Co4Mn | 0.002 | 4.05 | 0.23 | <0.005 | 0.002 | <0.01 | 0.41 | <0.01 | 7.96 |
| 8Co5Mn | 0.002 | 5.01 | 0.23 | <0.005 | 0.002 | <0.01 | 0.40 | <0.01 | 7.96 |
| 8Co6Mn | 0.002 | 5.91 | 0.24 | <0.005 | 0.002 | <0.01 | 0.40 | <0.01 | 7.96 |
| 15Co2Mn | 0.002 | 2.10 | 0.23 | <0.005 | 0.001 | <0.01 | 0.42 | <0.01 | 14.95 |
| 15Co2.7Mn | 0.002 | 2.66 | 0.33 | <0.005 | 0.002 | 0.30 | 0.02 | <0.01 | 14.91 |
| 15Co3Mn | 0.001 | 3.06 | 0.33 | <0.005 | 0.002 | 0.30 | 0.02 | <0.01 | 14.89 |
| 15Co3.2Mn | 0.002 | 3.22 | 0.33 | <0.005 | 0.002 | 0.29 | 0.02 | <0.01 | 14.89 |
| 15Co3.7Mn | 0.001 | 3.66 | 0.33 | <0.005 | 0.002 | 0.30 | 0.02 | <0.01 | 14.88 |
| 15Co4Mn | 0.002 | 4.11 | 0.23 | <0.005 | 0.002 | <0.01 | 0.41 | <0.01 | 14.94 |
| 15Co5Mn | 0.002 | 5.09 | 0.23 | <0.005 | 0.002 | <0.01 | 0.40 | <0.01 | 14.93 |
| 15Co6Mn | 0.002 | 6.03 | 0.23 | <0.005 | 0.002 | <0.01 | 0.40 | <0.01 | 14.91 |
| 17Co2Mn | 0.002 | 2.09 | 0.24 | <0.005 | 0.002 | <0.01 | 0.43 | <0.01 | 16.94 |
| 17Co4Mn | 0.002 | 4.09 | 0.23 | <0.005 | 0.002 | <0.01 | 0.41 | <0.01 | 16.94 |
| 17Co5Mn | 0.002 | 5.09 | 0.23 | <0.005 | 0.002 | <0.01 | 0.42 | <0.01 | 16.91 |
| 17Co6Mn | 0.001 | 6.03 | 0.27 | <0.005 | 0.002 | <0.01 | 0.41 | <0.01 | 16.90 |

The balance in each case is iron.

The ingots were hot-forged from 2200° F. to 0.5 inch by 2 inch slabs. The slabs were hot-rolled from 2100° F. to 0.25 inch thick strips. The strips were sand blasted to remove scale and then cold rolled to 0.060-0.080 inch thick. After annealing at 1300° F. for 2 hours in dry hydrogen, the strips were cold-rolled to 0.020 inch thick. Rings for DC magnetic testing were stamped and samples for resistivity measurements were machined from the 0.020 inch strip.

Table II below shows the results of testing on the various samples, including the resistivity (ρ) in micro-ohm centimeters (μΩ-cm), the DC magnetic induction (B) in kilogauss (kG) at 30, 50, 150, 200, and 250 Oe, and the coercive force (H_{c}) in oersteds (Oe) after each of four different heat treatments, HT1-HT6 as described below.

The data in Table II show that the 15Co—Fe alloys containing 2.66% to 3.06% manganese (15Co2.7Mn and 15Co3Mn) provides a magnetic induction (B@200 Oe) of 20.5 kG and 21.3 kG, respectively, combined with a resistivity (ρ) of 39.3 μΩ·cm and 42.2 μΩ·cm, respectively.

The data in Table II also show that the 8Co—Fe alloy containing about 2.08% manganese (8Co2Mn) provides magnetic induction values that are very similar to those of the 15Co3Mn alloy at a field strength of less than 100 Oe, although the resistivity is only slightly lower. This second preferred alloy would be useful in applications where a substantially lower cost material is required and the core loss and saturation requirement are less strict, such as land-based applications that operate at lower frequencies and lower field strengths.

The data presented in Table II show the good combination of magnetic properties (B@200 Oe of about 18-21 kG) and electrical resistivity (ρ of about 35-42 μΩ-cm) that is provided by the alloy according to the present invention.

The alloy according to the present invention stems from the discovery that manganese can be used to increase the resistivity of a Co—Fe soft magnetic alloy that contains less than about 20% cobalt. Manganese is a relatively inexpensive metal and does not significantly add to the cost of the alloy. Also, the scrap metal from producing the Co—Mn—Fe alloy of this invention can be readily recycled as scrap material for other grades to thereby reduce the overall cost of making the alloy. Thus, there will be less chance of contamination of other grades that are melted in the same VIM furnace. The Co—Mn—Fe alloy according to this invention can be melted easily, with easy composition control. It has good hot and cold workability.

TABLE II
Examples of Fe—Mn—Co alloys DC magnetic properties and
resistivities after various annealing heat treatments (HT)

| | | B | B | H_{c} | H_{c} | H_{c} | H_{c} | H_{c} | H_{c} |
|---|---|---|---|---|---|---|---|---|---|
| | Resistivity ρ | @ 30, 50, 150 200 Oe | @ 250 Oe | (Oe) | (Oe) | (Oe) | (Oe) | (Oe) | (Oe) |
| Heat ID | (μΩ· cm) | (kG) | (kG) | HT1 | HT2 | HT3 | HT4 | HT5 | HT6 |
| 8Co2Mn | 34.1 | 16.5; 17.0; 19.0; 19.6 | 20.1 | | 1.5 | 2.05 | 1.5 | 1.4 | |
| 8Co4Mn | 40.3 | 11.5; 13.6; 17.7; 18.4 | 18.2 | | 20.1 | 16 | 10.2 | 8.2 | |
| 8Co5Mn | 43.4 | 10.0; 12.7; 17.2; 17.7 | 18.6 | | | | | | |
| 8Co6Mn | 47.0 | 8.3; 11.8; 16.4; 17.4 | 17.3 | | | | | | |
| 15Co2Mn | 36.1 | 16.8; 17.5; 19.1; 20.3 | 21.1 | | 1.7 | 20 | 3.2 | 2.5 | 1.8 |
| 15Co2.7Mn | 39.3 | 16.3; 17.2; 19.6; 20.5 | | 4.1 | 7.2 | 22 | | | 1.9 |
| 15Co3Mn | 42.2 | 16.0; 17.4; 20.4; 21.3 | | 12.0 | 14.7 | | | | 3.1 |
| 15Co3.2Mn | 42.4 | 13.5; 15.4; 18.4; 19.3 | | 14.0 | 16.5 | | | | 3.8 |
| 15Co3.7Mn | 42.4 | 10.9; 13.7; 18.4; 19.3 | | 18.0 | 22 | | | | 9.2 |
| 15Co4Mn | 43.1 | 5.1; 8.4; 14.0; 15.1 | 18.9 | | 23 | 18 | 12 | 10.8 | 15.5 |
| 15Co5Mn | 45.0 | 6.4; 10.6; 16.0; 17.1 | 18.0 | | 30 | 21 | 16 | 14 | 17.8 |
| 17Co4Mn | 41.3 | 6.1; 8.8; 14.7; 15.9 | 16.1 | | 25 | | 12.5 | 11.5 | 11.5 |
| 17Co5Mn | 45.5 | 6.7; 10.0; 15.6; 16.8 | 17.4 | | >10 | 21 | 16 | 14.5 | 14.5 |

HT1 1320° F./2h
HT2 1400° F./2h/FC at 150° F./h
HT3 1600° F./2h
HT4 1742° F./4h/FC at 150° F./h to 1400° F., FC at 20° F./h, 1000° F., then FC at 150° F./h to RT
HT5 HT4 + 1742° F./20 min/FC at 20° F./h to 1200° F., then FC at 150° F./h to RT
HT6 2156° F./6h/FC at 200° F./h to 1290° F., then temper at 1290° F. for 24 hrs
FC = furnace cool

The terms and expressions that have been employed herein are used as terms of description and not of limitation. There is no intention in the use of such terms and expressions to exclude any equivalents of the features described or any portions thereof. It is recognized, however, that various modifications are possible within the scope of the invention claimed.

What is claimed is:

1. A soft magnetic steel alloy consisting essentially of, in weight percent, about 1.0-5.0% manganese, about 7-17% cobalt, and the balance essentially iron.

2. An alloy as set forth in claim 1 which also contains up to about 0.02% carbon.

3. An alloy as set forth in claim 1 which also contains up to about 0.3% silicon.

4. An alloy as set forth in claim 1 which also contains up to about 0.8% chromium.

5. An alloy as set forth in claim 1 which also contains up to about 0.8% nickel.

6. An alloy as set forth in any of claims 1-5 which contains at least about 1.8% manganese.

7. An alloy as set forth in claim 6 which contains not more than about 9% cobalt.

8. An alloy as set forth in claim 6 which contains at least about 14% cobalt.

9. A soft magnetic steel alloy consisting essentially of, in weight percent, about 2.2-3.2% manganese, about 14-16% cobalt, and the balance essentially iron.

10. An alloy as set forth in claim 9 which also contains up to about 0.02% carbon.

11. An alloy as set forth in claim 9 which also contains up to about 0.3% silicon.

12. An alloy as set forth in claim 9 which also contains up to about 0.8% chromium.

13. An alloy as set forth in claim 9 which also contains up to about 0.8% nickel.

14. A soft magnetic steel alloy consisting essentially of, in weight percent, about 1.8-2.4% manganese, about 7-9% cobalt, and the balance essentially iron.

15. An alloy as set forth in claim 14 which also contains up to about 0.02% carbon.

16. An alloy as set forth in claim 14 which also contains up to about 0.3% silicon.

17. An alloy as set forth in claim 14 which also contains up to about 0.8% chromium.

18. An alloy as set forth in claim 14 which also contains up to about 0.8% nickel.
